(19) United States
(12) Patent Application Publication
(10) Pub. No.: US 2011/0075816 A1
(43) Pub. Date: Mar. 31, 2011

(54) FILM SUPPORT

(76) Inventor: James Davis, Fallbrook, CA (US)

(21) Appl. No.: 12/569,589

(22) Filed: Sep. 29, 2009

(51) Int. Cl. G03B 42/02

(52) U.S. Cl. 378/181

(57) ABSTRACT

A film support includes a plate for supporting a film member against an underside of a target structure and a shaft for supporting the plate. The shaft includes a first end and a second end. The shaft first end is rotatably coupled to the plate and the shaft second end is configured to engage a supporting surface below the plate such that the plate is capable of being releasably positioned between the target structure underside and the shaft such that the film member is supported against the target structure underside.

### BACKGROUND OF INVENTION

This application relates generally to devices for holding film in a desired position.

### SUMMARY

It is occasionally necessary to determine location of inclusions within concrete structures, such as locating inclusions within a concrete column or slab. This situation may arise for example when contemplating core drilling or cutting through the concrete structure. It is highly desirable to avoid impinging upon inclusions, such as reinforcement bars (e.g., rebar), conduits, post tensioning cables, and the like. It may also be desirable to discriminate among inclusions, where several inclusions are in relatively close proximity to one another.

One method for locating inclusions within such structures involves X-raying the target structure. This typically involves positioning an X-ray machine atop the target structure and X-ray film against the underside of the target structure. While highly effective, positioning the film against the underside of the target structure may expose a user to potentially harmful X-rays. Therefore there exists a significant need for an improved means for supporting film against the underside of the target structure.

In particular, this application discloses a film support comprising: a plate for supporting a film member against an underside of a target structure; and a shaft for supporting the plate, the shaft having a first end and a second end, the shaft first end rotatably coupled to the plate and the shaft second end configured to engage a supporting surface below the plate such that the plate is capable of being releasably positioned between the target structure underside and the shaft such that the film member is supported against the target structure underside.

This application also discloses a film support comprising: a plate for supporting a film member against an underside of a target structure; a bracket member rotatably coupled to the plate; and a shaft having a first end and a second end, the shaft first end coupled to the bracket and the shaft second end configured to engage a supporting surface below the plate such that the plate is capable of being releasably positioned below structure underside such that the film member is supported against the target structure underside.

### BRIEF DESCRIPTION OF THE DRAWINGS

The drawings, when considered in connection with the following description, are presented for the purpose of facilitating an understanding of the subject matter sought to be protected.

FIG. 1 is a schematic perspective view of an illustrative film support;

FIG. 2A is a partial side view of an illustrative film support showing the plate in the first plate position;

FIG. 2B is a partial side view of an illustrative film support showing the plate in the second plate position;

FIG. 3 is a top view of an illustrative film support; and

FIG. 4 is a top view of an alternative illustrative film support.

### DETAILED DESCRIPTION

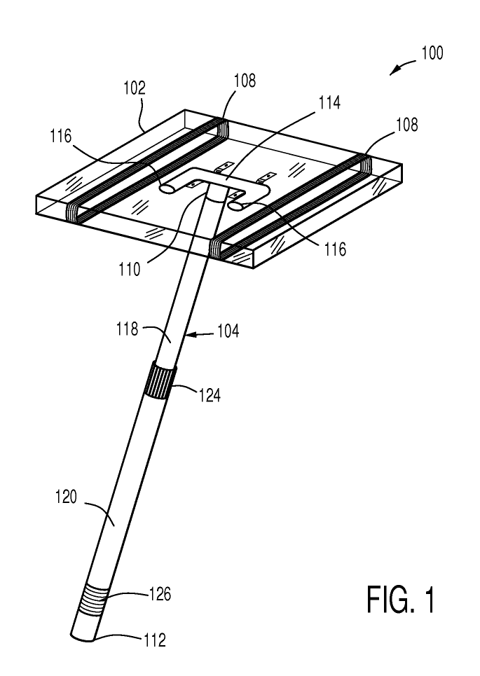

Referring now to FIGS. 1-3, an illustrative film support 100 is shown. The film support 100 generally includes a plate 102 and a shaft 104. The plate 102 is configured to support a film member 106 against an underside of a target structure. The plate 102 may be formed from any suitable material, including, but not limited to, metal, polymer, composite, etc. The plate 102 may include any suitable device for releasably securing the film member 106 thereto. In the illustrative embodiment, one or more elastic bands 108 are employed to releasably secure the film member 106 to the plate 102. However, it will be appreciated that any suitable device(s) or means, or any combination thereof, may be employed for releasably securing the film member 106 to the plate 102. For example, and without limitation, suitable device(s) may include Velcro®, magnets, straps, belts, hook-and-loop fasteners, snap fasteners, or any other suitable device(s) or means, or any combination thereof, for releasably securing the film member 106 to the plate 102. Also, while the illustrative film member 106 is shown as an X-ray cartridge typically employed with concrete, or structural, X-ray, it will be appreciated that any suitable film device may be employed and remain within the scope of the present disclosure.

The shaft 104 includes a first end 110 and a second end 112. The shaft first end 110 is rotatably coupled to the plate 102. In one embodiment, a bracket member 114 is coupled to the shaft first end 110 and rotatably coupled to the underside of the plate 102. It will be appreciated that the shaft first end 110 and/or bracket member 114 may be rotatably coupled to the plate 102 via any suitable means or device(s), or any suitable combination thereof, that permits the plate 102 to rotate relative to the shaft 104 and remain within the scope of the present disclosure. For example, as shown in the illustrative embodiment, one or more braces 111 are employed for rotatably coupling the plate 102 to the bracket member 114. Alternatively, and without limitation, the shaft first end 110 and/or bracket members 114 may be coupled to the plate 102 via one or more hinges, etc. In one embodiment, as will be discussed further below, the bracket member 114 includes one or more arms 116 for supporting the plate 102 in the plate first position.

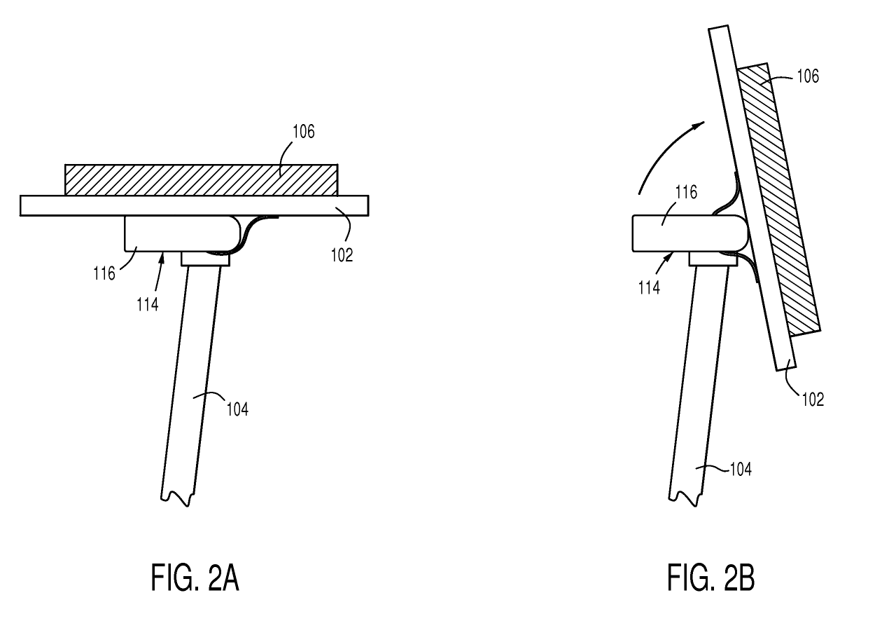

With particular reference to FIGS. 2A and 2B, the plate 102 is rotatable between a first position (e.g., FIG. 2A) and a second position (e.g. FIG. 2B). In one embodiment, the plate 102 is generally perpendicular to the shaft 104 in the first position (i.e., 90°+/−45° and the angle between the plate 102 and the shaft 104 is smaller in the second plate position than in the first plate position.

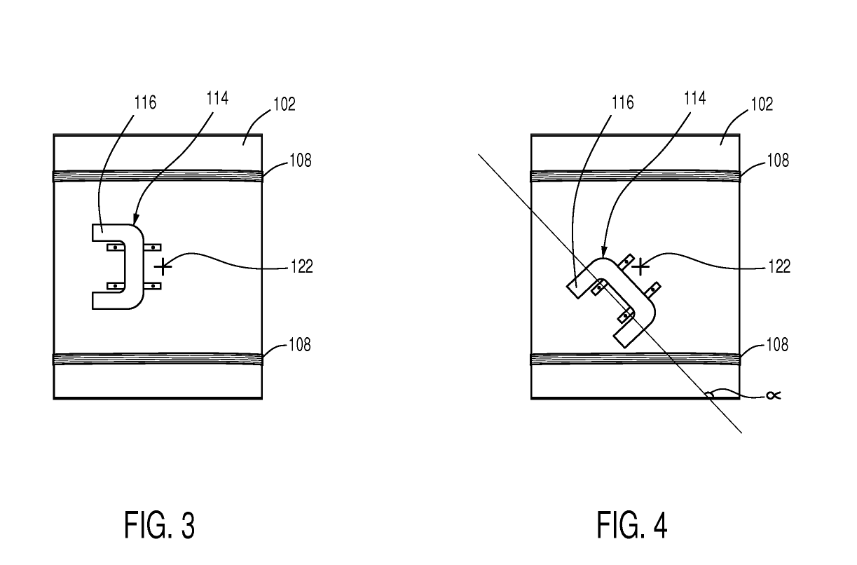

In one embodiment, as shown in FIG. 3, the shaft 104 is coupled to the plate 102 such that the shaft 104 is offset from the center of gravity 122 of the plate 102. In this embodiment, the supporting arms 116 on the bracket member 114 may support the plate 102 in the plate first position. The shaft 104 may then be axially rotated approximately 180 degrees whereby gravity may act on the plate 102 to rotate the plate 102 to the plate second position. In an alternative embodiment, as shown in FIG. 4, the shaft 102 may be coupled to the plate 102 such that shaft 104 is offset from the center of gravity 122 of the plate 102 and such that the bracket member 114 angled relative to the edges of the plate 102 (e.g., angle α). The bracket member supporting arms 116 may support the plate 102 in the plate first position and the shaft 104 may be axially rotated approximately 180 degrees whereby gravity may act on the plate 102 to rotate the plate 102 to the second position.

Referring again to FIGS. 1-3, the shaft 104 second end 112 is configured to engage a supporting surface below the plate 102 such that the plate 102 may be releasably positioned, or otherwise wedged, between the target structure underside and the shaft 104 such that the film member 106 is supported against the underside of the target structure and capable of receiving electromagnetic radiation passing through the target structure. For example, and without limitation, the shaft second end 112 may include a boot, a friction surface for frictionally engaging the supporting surface, etc.

In one embodiment, the shaft 104 may include a first portion 118 and a second portion 120 wherein the first portion 118 telescopically engages the second portion 120 such that the length of the shaft 104 may be selectively adjusted. The shaft 104 may include a locking member 124 for releasably securing the second portion 120 in position relative to the first portion 118. Moreover, the support 100 may include a resilient member 126 for absorbing, or at least partially absorbing, shock or vibration that may be introduced to, or near, the support 100. The resilient member 126 may be positioned near the shaft first end 110, shaft second end 112 or at any suitable position between the shaft ends 110, 112. In one embodiment, the resilient member 126 may also bias the plate 102 towards the underside of the target structure when the plate 102 is in the plate first position. The resilient member 126 may be any suitable device, including, but not limited to, a spring, a shock absorber, or any other suitable device.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A film support comprising:
a plate for supporting a film member against an underside of a target structure; and
a shaft for supporting the plate, the shaft having a first end and a second end, the shaft first end rotatably coupled to the plate and the shaft second end configured to engage a supporting surface below the plate such that the plate is capable of being releasably positioned between the target structure underside and the shaft such that the film member is supported against the target structure underside.

2. The film support of claim 1 wherein the shaft comprises a first portion and a second portion wherein the first portion telescopically engages the second portion.

3. The film support of claim 1 further comprising a resilient member for at least partially absorbing shock, the resilient member coupled to the shaft.

4. The film support of claim 1 wherein the plate is rotatable between a first position and a second position.

5. The film support of claim 5 wherein the plate is at a first angle relative to the shaft at the first position, and wherein the plate is at a second angle relative to the shaft at the second position.

6. The film support of claim 1 wherein the shaft first end is offset from the center of gravity of the plate.

7. The film support of claim 6 wherein the plate is rotatable between a first position and a second position.

8. The film support of claim 7 wherein axial rotation of the shaft from a first position to a second position causes the plate to rotate from the plate first position to the plate second position.

9. The film support of claim 8 wherein the plate is at a first angle relative to the shaft at the plate first position, and wherein the plate is at a second angle relative to the shaft at the plate second position.

10. The film support of claim 9 wherein the plate is generally perpendicular to the shaft at the plate first angle.

11. A film support comprising:
a plate for supporting a film member against an underside of a target structure;
a bracket member rotatably coupled to the plate; and
a shaft having a first end and a second end, the shaft first end coupled to the bracket and the shaft second end configured to engage a supporting surface below the plate such that the plate is capable of being releasably positioned below structure underside such that the film member is supported against the target structure underside.

12. The film support of claim 11 wherein the shaft comprises a first portion and a second portion wherein the first portion telescopically engages the second portion.

13. The film support of claim 11 further comprising a resilient member for at least partially absorbing shock, the resilient member coupled to the shaft.

14. The film support of claim 11 wherein the plate is rotatable between a first position and a second position.

15. The film support of claim 14 wherein the bracket member is offset from the center of gravity of the plate.

16. The film support of claim 15 wherein axial rotation of the shaft from a first position to a second position causes the plate to rotate from the plate first position to the plate second position.

17. The film support of claim 16 wherein the plate is at a first angle relative to the shaft at the plate first position, and wherein the plate is at a second angle relative to the shaft at the plate second position.

18. The film support of claim 17 wherein the plate is generally perpendicular to the shaft at the plate first angle.
